(19) United States
(12) Patent Application Publication
(10) Pub. No.: US 2004/0183434 A1
(43) Pub. Date: Sep. 23, 2004

(54) Electroluminescent element with double-sided luminous surface and process for fabricating the same

(76) Inventors: Yao Tsung Yeh, Chong Ho City (TW); Chun Chu Fu, Chong Ho City (TW); Chen Gyu Liu, Chong Ho City (TW); Chih Shen Chen, Chong Ho City (TW)

Correspondence Address: Yao Tsung Yeh, P.O. Box 10-69, Chong Ho, Taipei, 235, TW

(21) Appl. No.: 10/395,668

(22) Filed: Mar. 21, 2003

(51) Int. Cl. H01J 1/62

(52) U.S. Cl. 313/506; 313/504

(57) ABSTRACT

Eletroluminescent elements with doubled-sided luminous surface and feasible processes for making such elements are disclosed. Double-sided illuminating EL lamps comprise a common layer in the preferred multilayer structure are proposed, and the use of common layer in such double-sided illuminating EL lamps have the advantages of fewer layers, smaller thickness, less weights, fewer manufacturing steps and less cost without sacrificing any functional feature or performance. Such double-sided illuminating EL lamps may be fabricated by paste-coating or ink-printing method with a sequential-process or split-process, and these EL lamps provide two illuminating surfaces that can emit light simultaneously or independently depending on the design of EL structure and driver's circuit.

### BACKGROUND OF THE INVENTION

(1) Field of the Invention

The present invention relates to an electroluminescent element with double-sided luminous surface and processes for making the same, and more particularly to a thick film electroluminescent lamp of which both front and rear sides can emit light simultaneously or independently and the feasible methods for fabricating such an electroluminescent lamp.

(2) Description of the Prior Art

Electroluminescence (EL) is the energy transformation phenomenon of electric energy to photic energy. Owing to only very low heat generated during the operation, EL light is commonly called “cold light” or “cool light”. Through years of developments, EL elements can be categorized into thick film and thin film type, either of which can be driven by AC or DC power. The thick film EL is produced simply by printing ink or paste containing electroluminescent materials on suitable transparent substrate followed by other feasible procedures to implement the whole construction of EL element. On the other hand, the thin film EL is usually produced by complicated deposition methods or other peculiar procedures.

At present, the thick film EL driven by AC power (AC-EL) seems to be the most popular in the application of consumer's products. Generally, AC-EL device is essentially a capacitor structure with phosphor sandwiched between two electrodes inside which the complementary dielectric material, protecting or other functional materials are also applied. Application of an AC voltage generates a changing field within the phosphor, which causes the phosphor to emit light.

The electroluminescent element with above structure and operating principle is generally called EL lamp or EL light. EL lamp could be made and tailored into various shapes, patterns and different colors so as to be applied in different types of applications. The general operating voltage and frequency of AC-EL range from 50 to 200 volt and 50 to 3000 hertz approximately, and the recommended operating voltage and frequency is about 100 volt and 400 hertz respectively. Different voltage or frequency applied to AC-EL may affect the brightness and colors of EL lamps. Through the color mixing or filtering of emitted light, EL lamp can be also designed and produced to obtained different emitting colors such as blue, green, orange and even white light. It should be noted that inadequate application of voltage or frequency might reduce the EL lifetime and also bring detrimental side-effects for EL lamp.

Since the discovery of EL, EL lamp had find lot of applications in different areas such as backlights or lighting for portable electronics/instruments/vehicles, signs & advertising, decorative indication or lighting for appliance/gift/toy etc. However, conventional EL lamp generally comprises only one luminous surface due to its structural limitation, and EL lamp with single-sided luminous surface has drawback in the application of some areas such as signs & advertising. As a matter of fact, request for EL lamp with double-sided luminous surface has become urgent as the needs of EL lamp that can emit light in both sides, increase rapidly in recent years. Conventional thick film EL lamp generally comprises a laminate structure containing a transparent substrate, a transparent front electrode, a phosphor layer, a dielectric (insulating) layer, a rear electrode and optional protective layers etc. Thick film EL lamp based on above-described structure is impossible to have two luminous surfaces.

It is known in the common practice that attaching two conventional EL lamps with one luminous surface back-to-back is the simplest way for making EL lamp with double-sided luminous surface. In another preferred embodiment depicted in U.S. Pat. No. 5,976,613, a two-sided illuminating EL lamp was proposed in which a front electrode/clear dielectric/phosphor/white dielectric/common rear electrode/white dielectric/phosphor/clear dielectric/front electrode laminate structure was employed. In view of two afore-mentioned structures related to the EL lamp with double-sided luminous surface, common disadvantages such as complicated layers, extraordinary weight & thickness, high cost and tedious manufacturing steps are easily recognized. Despite of considerable efforts already made in this aspect, there still remains a need for an innovative structure design and more practical methods to fabricate a double-sided illuminating EL lamp.

### SUMMARY OF THE INVENTION

It is an object of the present invention to obviate or mitigate all or at least some above-mentioned disadvantages of double-sided illuminating EL lamp in the prior art.

It is another object of the present invention to propose novel, innovative and concise multilayer structures for an EL lamp with double-sided luminous surface.

It is yet another object of the present invention to provide adequate processes for manufacturing such EL lamps with double-sided luminous surface.

In accordance with one aspect of the invention, there is provided a double-sided illuminating EL lamp with a transparent substrate/transparent electrode/phosphor layer/dielectric layer/rear electrode/common protective or insulating layer/rear electrode/dielectric layer/phosphor layer/transparent electrode/transparent substrate multilayer structure, of which both front and rear sides can emit light simultaneously or independently. Furthermore, there is also provided a double-sided illuminating EL lamp with a transparent substrate/transparent electrode/phosphor layer/dielectric layer/common rear electrode/dielectric layer/phosphor layer/transparent electrode/transparent substrate multilayer structure, of which the front and rear sides can also emit light simultaneously or independently. Still furthermore, there is provided a double-sided illuminating EL lamp with a transparent substrate/transparent electrode/phosphor layer/common dielectric layer/phosphor layer/transparent electrode/transparent substrate multilayer structure, of which both front and rear sides can emit light simultaneously.

Accordingly, a double-sided illuminating EL lamp with preferred multilayer structure of present invention contains fewer layers, smaller thickness, less weights, fewer manufacturing steps and has less cost without sacrificing any functional feature or performance.

Further objectives and advantages of the present invention will become apparent from a careful reading of the detailed description provided hereinbelow with appropriate reference to the accompanying drawings.

### BRIEF DESCRIPTION OF THE DRAWINGS

FIG. 1 is a cross-sectional view of double-sided illuminating EL lamp with a common protective/insulating layer, of which both front and rear sides can emit light simultaneously or independently.

FIG. 2 is a cross-sectional view of double-sided illuminating EL lamp with a common rear electrode layer, of which both front and rear sides can emit light simultaneously or independently.

FIG. 3 is a cross-sectional view of double-sided illuminating EL lamp with a common dielectric layer, of which both front and rear sides can emit light simultaneously;

FIGS. 4A, 4B are block diagrams illustrating the manufacturing processes for the double-sided illuminating EL lamp with a common protective/insulating layer;

FIGS. 5A, 5B are block diagrams illustrating the manufacturing processes for the double-sided illuminating EL lamp with a common rear electrode layer;

FIGS. 6A, 6B are block diagrams illustrating the manufacturing processes for the double-sided illuminating EL lamp with a common dielectric layer.

### DETAILED DESCRIPTION OF PREFERRED EMBODIMENTS

The following is described to explain embodiments of the present invention with reference to the drawings.

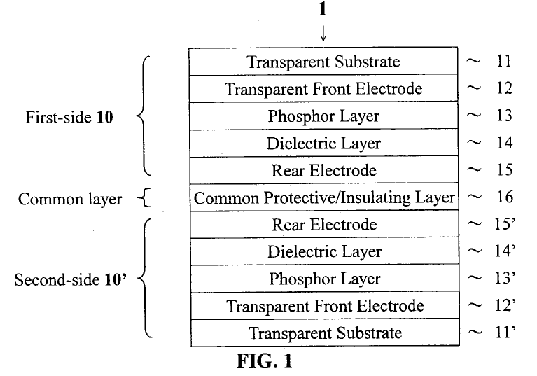

FIG. 1 shows a double-sided illuminating EL assembly 1 with a common protective/insulating layer which is similar to a double-sided illuminating EL device by simply attaching two single-sided illuminating EL lamps together. Basically, EL assembly 1 consists of four electrodes, as there are two electrodes in each single-sided illuminating EL element. Therefore, two sides of such EL assembly 1 can be operated separately or at the same time.

The transparent substrate 11 or 11′ may be the glass plates or polymer films made of, for example, polyethylene terephthalate (PET), polyethylene naphthalate (PEN), polyacrylate, polycarbonate, polystyrene, polysulfone, polyetheretherketone and fluororesins such as polyvinylidene fluoride, acryl-modified polyvinylidene fluoride, etc.; and the like. A material of the transparent substrate is merely required to have transparency with high light-transmission and is not limited to the above materials. Polymer film is preferably selected due to its flexibility to meet wide range of applications. Thickness of polymer film is usually between 50 to 200 μm (2 to 8 mil), while specific polymer with good thermal stability is preferably applied in some cases of application.

Transparent front electrode 12 or 12′ may be any transparent conductive material such as indium-tin oxide (ITO), antimony-tin oxide (ATO), indium oxide and the like, or even conductive polymers such as poly-3,4-ethylene dioxythiophene (PEDOT), polyaniline (PANI) etc. The transparent front electrode can be formed by any feasible film-forming methods such as sputtering, vapor deposition, paste coating, ink printing and the like. The thickness of the transparent electrode layer is usually between 0.1 to 1000 μm depending upon the film-forming method, while the surface resistivity is generally between 30 to 1000 Ω/□. The transparent electrode is either formed directly onto the transparent substrate or onto a primer layer that is pre-formed on the transparent substrate.

Phosphor layer 13 or 13′ is in direct contact with transparent front electrode. For thick film EL lamp, the phosphor layer is usually formed by paste-coating or ink-printing method from phosphor paste or ink that contains phosphor particles, binder resins, solvents and suitable additives etc. The phosphor particles are the luminescent powders that can emit light when they are placed in an electric field. Typical examples of phosphor are zinc sulfide (ZnS), cadmium sulfide(CdS), mixed sulfides of zinc and cadmium(ZnₓCd₁₋ₓS), doped with some activators and/or coactivators such as copper (Cu), manganese (Mn), silver (Ag), chlorine (Cl) etc. The average particle size of phosphor particles is usually between 5 to 100 μm, on which an encapsulated film of glass, ceramics, polymer and alike can be coated to improve the stability and moisture-resistance. Furthermore, the phosphor particles may be single-component or contain at least two kinds of particles that emit different color light for color-mixing purpose. The binder resin, served as the matrix resin for phosphor particles, may be any kind of polymer having high dielectric constant, preferably not less than 5 measured at 1 kHz, 25° C. Examples of the polymers having high dielectric constant are cyanoresins such as cyanoethyl pullulan, cyanoethyl polyvinylalcohol, cyanoethyl cellulose, cyanoethyl sucrose, cyanoethyl sorbitol etc., fluoropolymers such as polyvinylidene fluoride (PVDF), trifluoroethyl vinyl ether polymer, vinylidene fluoride-hexafluoropropylene copolymer, acryl-modified polyvinylidene fluoride, etc., nitrile compounds such as succinonitrile, butadiene-acrylonitrile rubber, phthalonitrile, etc., and polyester, epoxy, poly amide, acrylic resins or the like. Solvents impart the operability or printability for the phosphor paste or ink. Examples thereof include N,N-dimethylformamide (DMF), N,N-dimethylacetamide (DMAC), dimethylsulphoxide (DMSO), cyclohexanone, propylene carbonate, γ-butrolactone, isophorone, nitromethane, furfuryl alcohol, N-methyl-2-pyrrolidone (NMP), ethylbutyl acetate (EB acetate), terpineol, diethylene glycol monobutyl ether (butyl Carbitol), diethylene glycol monobutyl ether acetate(butyl Carbitol acetate), diethylene glycol monoethyl ether acetate and the like. The selection of the solvents is determined by the properties of resins applied, and mixed-solvent system is sometimes preferred in certain applications. Additives act as an aid in paste-coating or ink-printing processes, also serve to improve the film properties and enhance the performance of the phosphor layer. Typical examples of the additives are defoaming agent such as silicone fluid, coupling agent such as alkoxysilane compound, dispersing agent such as polymeric dispersant or surfactant, plasticiser, hardener, drying or hygroscopic agent, leveling agent, rheology modifier, stabilizer, wetting agent, dye or pigment, fluorescent material etc. The dry film thickness of the phosphor layer is usually between 10 to 50 μm depending on the particle size of the phosphor powder and the number of coatings or prints. It is well recognized that the thickness of phosphor layer has close relevance to the luminance of EL lamp.

Dielectric layer 14 or 14′ is directly deposited onto the phosphor layer. Similar to the phosphor layer, the dielectric layer is usually formed by applying paste-coating or ink-printing method with dielectric paste or ink containing dielectric particles, binder resins, solvents and suitable additives etc. The dielectric particles commonly employed are inorganic ferroelectric substance with high-dielectric constant such as barium titanate (BaTiO₃), lead titanate (PbTiO₃), strontium titanate (SrTiO₃), titanium dioxide (TiO₂) and the like. The average particle size of dielectric particles is usually between 0.1 to 10 μm and the dielectric particles may be single-component or multi-components of particles for specific purpose. The binder resin, also served as a matrix resin, may be any kind of polymer having high dielectric constant just like those for the phosphor layer. However, binder resin applied for the dielectric layer may be the same as or different from that of phosphor layer. Solvents for the dielectric paste or ink can refer to those examples aforementioned for the phosphor paste or ink. The application and selection guide for the solvent is in accordance with the same concept and criteria. Additives for the dielectric layer are almost the same as those applicable for the phosphor layer. Typical examples of the additives are defoaming agent such as silicone fluid, hydrophobic alkoxysilane compound, dispersing agent such as polymeric dispersant or surfactant, plasticiser, hardener, drying or hygroscopic agent, viscosity modifier etc. The dry film thickness of the dielectric layer is usually between 10 to 50 μm depending on requirements of lamp's reliability and brightness.

Rear electrode 15 or 15′ may be any conductive material made from silver (Ag), aluminum (Al), copper (Cu), gold (Au), nickel (Ni), chromium (Cr), carbon (C) and the like, and transparent conductive materials such as indium-tin oxide (ITO) or poly-3,4-ethylene dioxythiophene (PEDOT) are also applicable. Rear electrode layer may be formed directly from metal film of above-mentioned conductive material or may be deposited through paste-coating or ink-printing method by use of conductive paste or ink. Conductive paste or ink based on silver or carbon/graphite are commercially available from many vendors, and polyester, polyurethane, epoxy and acrylic resins are some of the examples used as the binder resins in the commercial conductive paste or ink. The dry film thickness of the rear electrode layer is usually between 5 to 50 μm depending on the requirements of lamp and the properties of the conductive paste/ink.

Layer 16 serves as the insulative or the protective coat layer for the EL element. It can be formed by applying the insulative/dielectric paste or ink. The insulative/dielectric paste/ink can be either UV-curable or thermal-curable as the resins usually applied are acrylic, urethane acrylate etc. The film thickness of the insulative/protective layer is usually between 20 to 70 μm depending on the electrical requirements.

There are four electrodes, two electrodes for each side, existing in lamp 1 depicted in FIG. 1. Accordingly, such a lamp may be constructed as a four-terminal, three-terminal system or even into a two-terminal system. Therefore, two sides of such EL assembly 1 can be operated separately or at the same time with adequate design of driver's (i.e. inverter's) circuit.

It should be noted that some optional layers such as desiccant layer, low-moisture-permeability layer, barrier layer and other functional layers in more elaborate embodiments of EL elements are not shown in the figures. The desiccant layer usually consists of water-absorbing materials such as nylon, polyvinyl acetate polymers and/or hydrophilic materials such as calcium chloride, calcium bromide, sodium sulfate, calcium sulfate etc., while the low-moisture-permeability layer is usually a protective film made of hydrophobic materials such as poly(chlorotrifluoroethylene) (PCTFE), poly(ethylene) (PE) and the like.

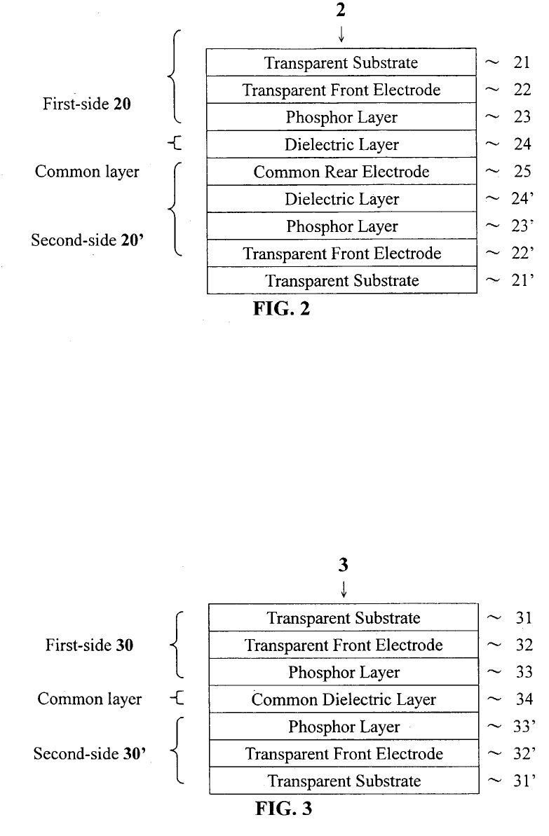

FIG. 2 shows a double-sided illuminating EL assembly 2 with a common rear electrode, which is similar to the EL embodiment depicted in U.S. Pat. No. 5,976,613. However, two clear dielectric layers between the respective front electrode and phosphor layers in the laminate structure are omitted in order to have thinner EL construction and, thus, obtain higher luminance. Each layer, i.e. transparent substrate 21 or 21′, transparent front electrode 22 or 22′, phosphor layer 23 or 23′, dielectric layer 24 or 24′, common rear electrode 25, can be formed by using the same materials as those described in EL assembly 1. It is obvious that EL assembly 2 is a three-electrode system. Therefore, it is more compact and cost-effective than EL assembly 1. It is also worthy to mention that two sides of such EL assembly 2 can be operated separately or at the same time with adequate design of driver's (i.e. inverter's) circuit.

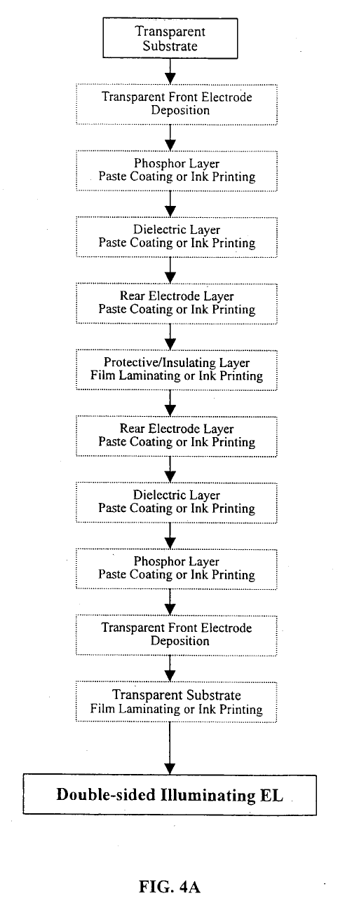

FIG. 3 shows the most preferred embodiment in this invention of a double-sided illuminating EL assembly 3 with a common dielectric layer. It is further improved by minimizing the required layers for a double-sided illuminating EL element and reducing the complexity of the manufacturing process. Again, each individual layer, which is the transparent substrate 31 or 31′, transparent front electrode 32 or 32′, phosphor layer 33 or 33′ and common dielectric layer 24 respectively, can be formed by using the same materials as those described in EL assembly 1. Referring to FIG. 3, it is easily seen that EL assembly 3 is a two-electrode system that is much thinner and more compact compared to EL assembly 1, or even to EL assembly 2. It should be specially noted that two sides of such EL assembly 3 could be only operated simultaneously owing to limited electrodes. Nevertheless, most of the EL applications with the requirement of double-sided illuminating surfaces only need synchronous operation for both sides.

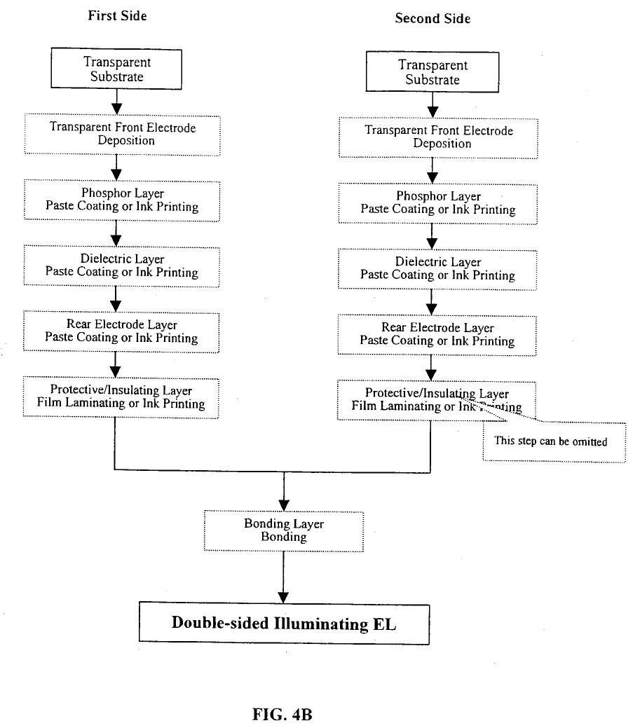

FIG. 4 is a block diagram illustrating the manufacturing processes for the double-sided illuminating EL lamp 1 depicted in FIG. 1 of which the structure is designed to have a common protective/insulating layer. FIG. 4A describes the sequential-process to implement a double-sided illuminating EL lamp with a common rear electrode, while FIG. 4B explains the split-process to fabricate such a lamp. In sequential-process FIG. 4A, in which the starting material may be either the transparent substrate such as PET film or transparent conductive substrate such as ITO/PET film for convenience, every layer is deposited stepwise by paste-coating or ink-printing method that is already known in the arts. In split-process FIG. 4B, each side is fabricated separately in which every layer in each side is also deposited stepwise by the same paste-coating or ink-printing method. However, a bonding layer which is not shown in FIG. 4 is required to combine the two sides into a single double-sided illuminating EL lamp with a common protective/insulating layer. There are two electrodes for each side respectively for this double-sided illuminating EL lamp and two pairs of electrodes for each side can be operated separately or synchronously. The terminals for the two separate rear electrodes in each side can be attached together, which results in a three-terminal system. Two luminous sides of the double-sided illuminating EL lamp with a three-terminal system can be operated separately or at the same time with adequate design of driver's (i.e. inverter's) circuit. In addition, two front electrodes in each single-sided illuminating EL lamp can be further combined into two-terminal system. In such a case, two luminous sides of the double-sided illuminating EL lamp can be only operated simultaneously.

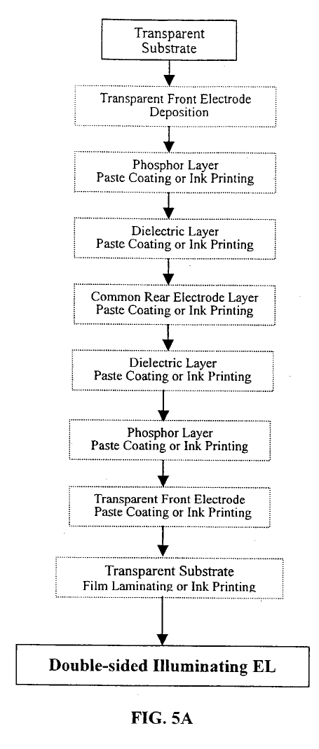

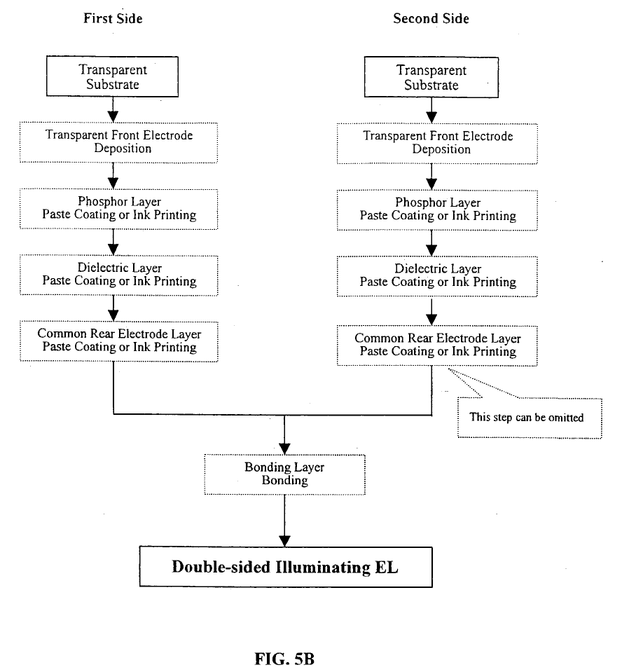

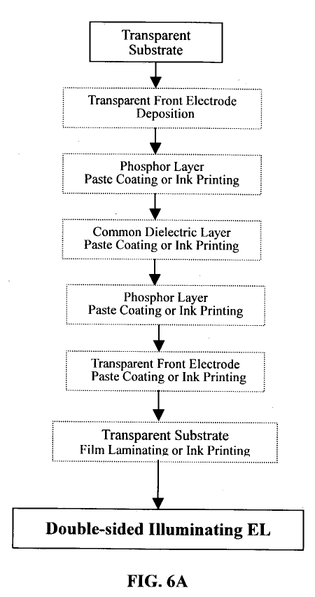

FIG. 5 is a block diagram illustrating the manufacturing processes for the double-sided illuminating EL lamp 2 depicted in FIG. 2, of which the structure is designed to have a common rear electrode layer. FIG. 5A describes the sequential-process to implement a double-sided illuminating EL lamp with a common rear electrode, while FIG. 5B explains the split-process to fabricate such a lamp. In sequential-process FIG. 5A, in which the starting material may be either the transparent substrate such as PET film or transparent conductive substrate such as ITO/PET film for convenience, every layer is deposited stepwise by paste-coating or ink-printing method which is already known in the arts. In split-process FIG. 5B, each side is fabricated separately in which every layer in each side is also deposited stepwise by the same paste-coating or ink-printing method. However, a bonding layer which is not shown in FIG. 5 is required to combine the two sides into the a single double-sided illuminating EL lamp with a common rear electrode. There are three electrodes, one common rear electrode and two front electrodes, existing in lamp 2 depicted in FIG. 2. Accordingly, such a lamp may be constructed as a three-terminal system or into a two-terminal system. Therefore, two sides of such EL assembly 2 can be also operated separately or at the same time with adequate design of driver's (i.e. inverter's) circuit.

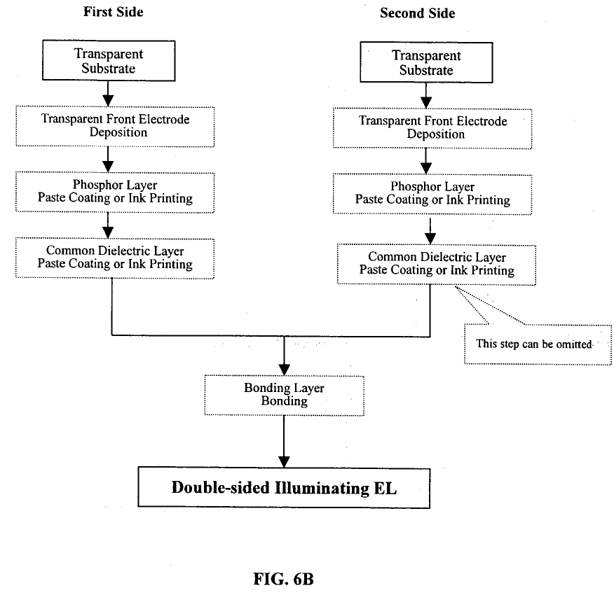

FIG. 6 is a block diagram illustrating the manufacturing processes for the double-sided illuminating EL lamp 3 depicted in FIG. 3, of which the structure is designed to have a common dielectric layer. FIG. 6A describes the sequential-process and FIG. 6B explains the split-process to fabricate such a lamp. In both sequential-process FIG. 6A and split-process FIG. 6B, every functional layer is deposited stepwise by aforementioned paste-coating or ink-printing method. But in split-process FIG. 6B, each side is fabricated separately and a bonding layer which is not shown in FIG. 6 is required to combine the two sides into the a single double-sided illuminating EL lamp with a common dielectric layer. There are two electrodes for the double-sided illuminating EL lamp 3 as shown in FIG. 3. Owing to the fact that only two electrodes exist in the lamp, the two sides of such EL assembly 3 can be only operated simultaneously.

### EXAMPLES

Present invention will be described in more detail with reference to examples to fabricate a double-sided illuminating EL lamp with a common dielectric layer, but should not be construed to be limited thereto.

### Example I

To make a double-sided illuminating EL lamp with a common dielectric layer according to the sequential-process described in FIG. 6A, a commercial ITO/PET laminate film (such as OC-100 manufactured by CPFilms) was used as transparent conductive substrate for convenience. The ITO/PET film is about 125 μ in thickness and had an ITO transparent conductive layer that was sputtered onto one surface of the PET film. This transparent conductive film has a surface resistivity of 70-90 Ω/□ and a VLT(Visual Light Transmittance) about 78%.

The deposition step of the first transparent front electrode depicted in FIG. 6A was not required in this example because the applied substrate is an ITO/PET film of which the transparent conductive electrode had been already pre-deposited.

A paste for forming the first phosphor layer was prepared by mixing phosphor (such as IGS230 manufactured by OSRAM-SYLVANIA), binder resin (such as Cyanoresin manufactured by Shin-Etsu), solvents (such as cyclohexanone, DMF etc.) and other suitable additives. To control the body color and illuminating color of this phosphor layer, some specific colorants and fluorescent materials may be added into the phosphor paste for this purpose. This paste was screen-printed onto the ITO side of the ITO/PET film by controlling the dry film-thickness to about 30-40 μm.

Next, a paste for forming the common dielectric layer was also prepared by mixing BaTiO₃ (such as TICON barium titanate manufactured by FERRO), binder resin (such as Cyanoresin manufactured by Shin-Etsu), solvents (such as cyclohexanone, DMF etc.) and other suitable additives. This paste was screen-printed onto the top of the phosphor layer by controlling the dry film-thickness to about 15-30 μm of which the thickness was determined by the requirements of luminance and reliability.

Again, the second phosphor layer was placed in direct contact with the common dielectric layer by using the similar phosphor paste used for forming the first phosphor layer. However, different colorants and fluorescent materials may be added into this phosphor paste if different body color and illuminating color for each luminous surface is needed. This paste was screen-printed onto the common dielectric layer by controlling the dry film-thickness to about 30-40 μm.

To implement the second transparent front electrode, the transparent conductive polymer PEDOT (such as Orgacon Printing Paste manufactured by AGFA) was applied in this case. This commercial polymeric printing paste was screen-printed onto the second phosphor layer by controlling the dry film-thickness to about 5-20 μm, and it is believed to have a surface resistivity less than 2 KΩ/□ and a VLT (Visual Light Transmittance) more than 90% according to its application notes. An alternative to the transparent conductive polymer for forming this second transparent front electrode was a screen printable ITO or ATO translucent conductive ink (such as 7160 series translucent conductors manufactured by DuPont).

Finally, a transparent polyester film with a thickness in the range of 100 to 200 μ (such as Mylar PET polyester film manufactured by DuPont-Teijin) was used to laminate on the second transparent front electrode layer, and served as a second transparent substrate with insulating and protective purpose.

It should be noted that some trivial build-sequence steps, such as bus-bar printing and power-terminals installation etc., required to implement an applicable EL lamp were not described in the above procedures.

The double-sided illuminating EL lamp obtained was equipped with a compatible inverter. The characteristics of this double-sided illuminating EL lamp driven at AC 100 Vᵣₘₛ and 400 Hz under normal room temperature and humidity are explained in TABLE I.

TABLE I
Double-sided illuminating EL lamp fabricated
according to the sequential-process

| | | | Second Luminous |
|---|---|---|---|
| | | First Luminous Surface | Surface |
| Body Color | | Pink | Light Purple |
| Illuminating | CIE(X, Y) | (0.3704; 0.6023) | (0.3283; 0.3744) |
| Color | | | |
| Luminance | (cd/m²) | 43.3 | 21.8 |

It is clear that the double-sided illuminating EL lamp in this case has two luminous surfaces with different body color, illuminating color and luminance (i.e. brightness) etc., but it is preferred in some specific applications. Owing to fact that the different front electrode materials were applied in the first and second transparent front electrodes, which are ITO and PEDOT respectively, each transparent conductive electrode has different surface resistivity, light transmittance and tinted color. Moreover, various colorants and fluorescent materials may be added into the formulation of the phosphor paste for the color-tuning purpose.

### Example II

To make a double-sided illuminating EL lamp with a common dielectric layer according to the split-process described in FIG. 6B, a commercial ITO/PET laminate film (same as that in Example I) was used as transparent conductive substrate for convenience. The deposition step of the first transparent front electrode depicted in FIG. 6B was not required because the ITO transparent conductive electrode had been already pre-deposited on the PET film.

A paste for forming the first phosphor layer in the first side was prepared in the same way described in Example I. This paste was screen-printed onto the ITO side of the ITO/PET film by controlling the dry film-thickness to about 30-40 μm.

Next, a paste for forming the first common dielectric layer in the first side was also prepared in the same way described in Example I. This paste was screen-printed onto the top of the phosphor layer by controlling the dry film-thickness to about 5-20 μm of which the thickness was determined by the requirements of luminance and reliability.

Again, the second phosphor layer and the second common dielectric layer in the second side were formed on another ITO/PET film by following the same procedures for the first side. However, the step for forming the second common dielectric layer in the second side can be omitted if dry film-thickness of the first common dielectric layer is good enough (about 15-30 μm) for the required luminance and reliability.

To implement an applicable double-sided illuminating EL lamp, bonding between these two pieces of luminous sides is essential. Bonding may be formed by using any kind of adhesives either in liquid-type or film-type only if they have the adequate electrical property, dielectric property, adhesiveness and operability to obtain good performance.

The double-sided illuminating EL lamp obtained was also equipped with a compatible inverter. The characteristics of this double-sided illuminating EL lamp driven at AC 100 Vᵣₘₛ and 400 Hz under normal room temperature and humidity are explained in TABLE II.

TABLE II
Double-sided illuminating EL lamp fabricated according
to the split-process

| | | | Second Luminous |
|---|---|---|---|
| | | First Luminous Surface | Surface |
| Body Color | | Light Yellow | Light Yellow |
| Illuminating | CIE(X, Y) | (0.2159; 0.7323) | (0.2159; 0.7323) |
| Color | | | |
| Luminance | (cd/m²) | 28.1 | 29.6 |

In this case, identical substance including substrate material, front electrode material and dielectric material were applied for both sides of the two luminous elements. It is no wonder that this double-sided illuminating EL lamp has two luminous surfaces with similar body color, illuminating color and luminance.

Although this invention has been described with a certain degree of particularity, it is to be understood that the present disclosure has been made by way of specific examples only and that numerous changes in the detailed construction or the combination and arrangement of parts may be resorted to without departing from the spirit and scope of the invention as hereinafter claimed.

I claim:

1. A double-sided illuminating EL lamp with a multilayer structure comprising:
a) transparent substrate,
b) transparent electrode,
c) phosphor layer,
d) dielectric layer,
e) rear electrode,
f) common protective or insulating layer,
g) rear electrode,
h) dielectric layer,
i) phosphor layer,
j) transparent electrode,
k) transparent substrate,
wherein said double-sided illuminating EL lamp provides two illuminating surfaces that can emit light simultaneously or independently with the aid of an adequate driver (i.e. an inverter), and the feasible processes for fabricating the double-sided illuminating EL lamp can be categorized into:
a) sequential-process in which the double-sided illuminating EL lamp is fabricated by depositing every functional layer stepwise.
b) split-process in which the two sides of the double-sided illuminating EL lamp is fabricated separately and bonded back-to-back with any suitable methods.
which are described in details in the detailed description of preferred embodiments.

2. A double-sided illuminating EL lamp with a multilayer structure comprising:
a) transparent substrate,
b) transparent electrode,
c) phosphor layer,
d) dielectric layer,
e) common rear electrode,
f) dielectric layer,
g) phosphor layer,
h) transparent electrode,
i) transparent substrate,
wherein said double-sided illuminating EL lamp provides two illuminating surfaces that can emit light simultaneously or independently with the aid of an adequate driver (i.e. an inverter), and the feasible processes for fabricating the double-sided illuminating EL lamp can be categorized into:
a) sequential-process in which the double-sided illuminating EL lamp is fabricated by depositing every functional layer stepwise.
b) split-process in which the two sides of the double-sided illuminating EL lamp is fabricated separately and bonded back-to-back with any suitable methods.
which are described in details in the detailed description of preferred embodiments.

3. A double-sided illuminating EL lamp with a multilayer structure comprising:
a) transparent substrate,
b) transparent electrode,
c) phosphor layer,
d) common dielectric layer,
e) phosphor layer,
f) transparent electrode,
g) transparent substrate,
wherein said double-sided illuminating EL lamp provides two illuminating surfaces that can emit light simultaneously with the aid of an adequate driver (i.e. an inverter), and the feasible processes for fabricating the double-sided illuminating EL lamp can be categorized into:
a) sequential-process in which the double-sided illuminating EL lamp is fabricated by depositing every functional layer stepwise.
b) split-process in which the two sides of the double-sided illuminating EL lamp is fabricated separately and bonded back-to-back with any suitable methods.
which are described in details in the detailed description of preferred embodiments.
